(19) United States
(12) Patent Application Publication
(10) Pub. No.: US 2012/0201927 A1
(43) Pub. Date: Aug. 9, 2012

(54) Hollow Sandwich Bun Mold and Method of Use

(76) Inventor: Shirley Meikle, Edmonton (CA)

(21) Appl. No.: 13/198,261

(22) Filed: Aug. 4, 2011

Related U.S. Application Data
(60) Provisional application No. 61/418,628, filed on Dec. 1, 2010.

(51) Int. Cl. A21D 8/06; A23P 1/10

(52) U.S. Cl. 426/62; 425/357

(57) ABSTRACT

A sandwich bun mold device and method for use are provided for creating sandwich buns having hollow interior regions. The device comprises a bread mold pan having a plurality of mold recesses disposed along its surface, a pan cover, and a plurality of inserts of varying size and shape. To make the buns, a user places yeast bread dough in the mold recesses and then selects a desired insert size that will correspond to the size of the hollow interior region after the bun has cooked. The insert is then placed on the bread dough and the pan cover is placed onto the pan. A user bakes the assembly until the buns are cooked, removes the cover and inserts, and inverts the device to remove the freshly prepared buns.

### CROSS REFERENCE TO RELATED APPLICATION

This application claims the benefit of U.S. Provisional Application No. 61/418,628 filed on Dec. 1, 2010, entitled “Hollow Bun.”

### BACKGROUND OF THE INVENTION

1. Field of the Invention

The present invention relates to a device and method for producing sandwich buns. More specifically, the present invention provides a mold for a hollow sandwich bun and a process for making the same.

Sandwich eaters are keenly aware of the regular occurrence of sandwich contents and condiments spilling out from a sandwich bun that is supposed to contain the same. Contents spill out due to squeezing of a bun by a user, or jostling of the sandwich while in the consumer's possession. These contents may fall on the floor or onto the user themselves. The loss of sandwich contents may merely be disappointing if the result is missing lunch foods and messy clothes that get spilled on; however if the contents are hot and fall onto a user's bare skin, the user could receive mild burns. Hot sandwiches such as cheesesteaks, hot dogs with chili, and sandwich melts all contain elements that are served hot and can burn if brought into contact with a user's skin.

Different means and methods of containing sandwich contents have been created to prevent spillage, including paper sleeves, plastic wraps, and similar non-edible coverings. Outer wraps can be problematic because they can become soggy from contact with sandwich contents and drip onto the ground or a user. Additionally these wrap materials become difficult to manage as a user reaches the end of a sandwich, exposing the user to a risk of ingesting parts of the wrapping material. These wrap materials also generate considerable environmental waste, which is discarded in the trash and not always recycled. A means for containing sandwich contents within a bun or roll is needed that does not present an ingestion danger to the user, eliminates waste and provides an improved means for containing sandwich contents and condiments.

2. Description of the Prior Art

The prior art contains a variety of bread mold devices for making bread buns having pocket recesses therein. These devices have familiar design and structural elements for the purposes of sandwich bun making, however they are not adapted for the task of making sandwich buns having varying sizes of pocket recesses.

Heiderpriem, U.S. Pat. No. 4,065,581 discloses a mold for making a hot dog bun having a deep centrally located recess. The mold has four edges and is raised in the center along its lateral length. Yeast dough may be placed on top of the mold and then baked to create a hot dog bun with a lateral recess. Heiderpriem discusses multiple methods for using its contoured mold to make the bun product. It does not disclose a method for generating buns having varying sized pocket recesses. Heiderpriem also does not disclose a plurality of inserts of varying size that are used to create a hollow region within a bun while baking.

Groulx et al, U.S. Pat. No. 5,897,900 discloses an edible hot dog bun and a mold for making the same. The bun has two sidewalls and a base joined to the lower lateral wall of said side portions. The sidewalls are thinner at their top edges than they are at their lower edges. A mold is provided having a female base member, a male insert, and a lid. Bread yeast is placed within said female base member; the male insert is then placed on the dough to form the shape of the hot dog bun. The lid is then placed on the mold and it is baked. The inserts are formed in the shape of inverted bread molds that are lowered onto the female bread mold member. These inserts do not vary in size and shape, nor are they place on the bread dough such that the insert contacts only a central portion of the dough. The present device and method require an insert to be placed directly onto the dough and a baking sheet cover to be lowered onto the mold. The inserts of Groulx also act as the effective mold cover for the purpose of baking. Groulx does not disclose a method of making sandwich buns having hollow areas of varying size.

Leach et al, U.S. Patent Application Publication No. 2007/0235627 discloses a pan for baking pocket-shaped sandwich buns. It includes a surface having a plurality of recesses in which dough is placed. Said recesses have a centrally located ridge for the purposes of forming a pocket within the bun. The pan may have a lid hingedly affixed to one edge. In one embodiment, the mold recesses are shaped to form hot dog buns. In an alternative embodiment, the mold recesses are cylindrical to form hamburger buns. Leach discloses the manufacturing process of placing dough in the pocket-bun pan, lowering the lid and baking the pan. Once the pan is removed from the oven and cooled, it may then be inverted and opened to remove the pocket-shaped buns. Leach contemplates the use of a ridge built into the bread mold to create pocket areas within the bun; it does not contemplate the use of inserts of varying size and shape. Furthermore, Leach does not disclose a method for creating sandwich buns having hollow regions of varying size.

Bernard, U.S. Patent Application Publication No. 2010/0055258 discloses a hot dog bun having two halves joined along one edge. At least one of the halves contains a groove along its length. The groove may extend from a first side of the bun half to an opposing side, or alternatively may extend along a portion of the bun half's length. The groove may have a variety of shapes and widths depending on the intended use of the bun. Bernard does not disclose the process of making a hot dog bun having varying sizes of pocket recesses. Additionally, Bernard discloses and claims only the sandwich bun product and not a mold for making the same. As such, Bernard does not contemplate a plurality of inserts of varying sizes for placement upon yeast bread dough to create hollow recesses within the bun product.

The aforementioned devices disclosed in the prior art do not address the need for creating pocket recesses of varying size, nor do they disclose a method of producing bread buns with an internal recess of varying dimension based on user preferences. The current invention relates to a device and method for creating sandwich buns having hollow regions of varying size. It substantially diverges in structural elements from the prior art, and consequently it is clear that there is a need in the art for an improvement to the existing sandwich bun making devices and methods. In this regard, the instant invention substantially fulfills these needs.

### SUMMARY OF THE INVENTION

In view of the foregoing disadvantages inherent in the known types of sandwich bun molds now present in the prior art, the present invention provides a new device and method for making sandwich buns having varying sizes and shapes of hollow recesses wherein the same can be utilized for providing convenience for the user when making sandwich buns with a hollow interior of a desired dimension. The device comprises a bread yeast mold, a pan cover, and a plurality of cylindrical inserts of varying size. The bread mold pan has a plurality of geometrically shaped recesses disposed about its surface. These recesses may be positioned into rows and columns to facilitate optimization of the pan surface area. The bread yeast recesses may be shaped to form two conjoined halves of a sandwich bun, or alternatively may be shaped to form a single side of a sandwich bun.

A plurality of inserts is provided having varying dimensions. A first set of the inserts may comprise cylindrical rods having varying length and diameter. For the purposes of making hamburger buns, a second set of inserts may be formed in the shapes of discs of varying height and diameter. Other shapes such as parallelepoids, tori, and novelty shapes are contemplated. These inserts are placed onto bread yeast dough positioned within a mold recess to create a hollow pocket of desired shape and size as the bread is baked. The pan cover fits over top of the bread pan and is used when baking the bread dough to facilitate even baking of all surfaces of the dough, and prevent debris within the oven from falling onto the baking dough

The method of using the bread mold device to make hollow-recess buns comprises filling the bread mold recesses of a bread pan with yeast dough, selecting an insert according to the desired size and shape of a recess in the finished product, placing inserts onto the yeast dough contained within a bread mold recess and lowering the pan cover onto the bread pan. The process further comprises placing the mold device in an oven, baking until the dough is fully cooked, and removing it from the oven. The pan cover and inserts are then removed, allowing the baked bread to cool and inverting the bread pan to remove the sandwich buns therefrom. In this manner, a user may create sandwich buns having hollow regions of a desired size and shape.

It is therefore an object of the present invention to provide a new and improved sandwich bun mold device and method having all the advantages of the prior art and none of the disadvantages.

Another object of the present invention is to provide a new and improved sandwich bun mold device having a plurality of inserts of different sizes to facilitate creation of hollow recesses within a sandwich bun according to a user's preference.

Yet another object of the present invention is to provide a new and improved sandwich bun mold device having a plurality of inserts of different shape for allowing a user to create hollow regions within a sandwich bun in any arrangement.

Still another object of the present invention is to provide a new and improved sandwich bun mold device having a bread pan for creating a sandwich bun having conjoined halves/

Another object of the present invention is to provide a new and improved sandwich bun mold device having a cover that reduces the risk of oven debris falling onto the baking dough.

Yet another object of the present invention is to provide a new and improved method for making hollow sandwich buns, wherein the steps provide a user with an option of selecting a desired insert size and shape for creating a hollow region within a sandwich bun product.

A further object of the present invention is to provide a new and improved sandwich bun mold device having durable and resilient construction.

A still further object of the present invention is to provide a new and improved method for making hollow sandwich buns that employs steps that are easy for a user to follow, and are efficient with respect to time and resources.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above as well as other objects not stated above will become more apparent after a study of the following detailed description thereof. Such description makes use of the annexed drawings wherein like reference numerals are carried throughout.

FIG. 1 shows a perspective view of the present sandwich bun mold device while in use.

FIG. 2 shows a perspective view of the present sandwich bun mold device with the pan cover lowered over the bread mold pan.

FIG. 3 shows a perspective view of the product created by the present device and method.

FIG. 4 shows a perspective view of the product created by the present device and method.

FIG. 5 shows a flow chart depicting the steps of the present process.

### DETAILED DESCRIPTION OF THE INVENTION

Reference is made herein to the attached drawings. Like reference numerals are used throughout the drawings to depict like or similar elements of the sandwich bun mold device and method for making the same. For the purposes of presenting a brief and clear description of the present invention, the preferred embodiment will be discussed as used for making hollow sandwich buns. This is for representative purposes only and should not be considered to be limiting in any respect.

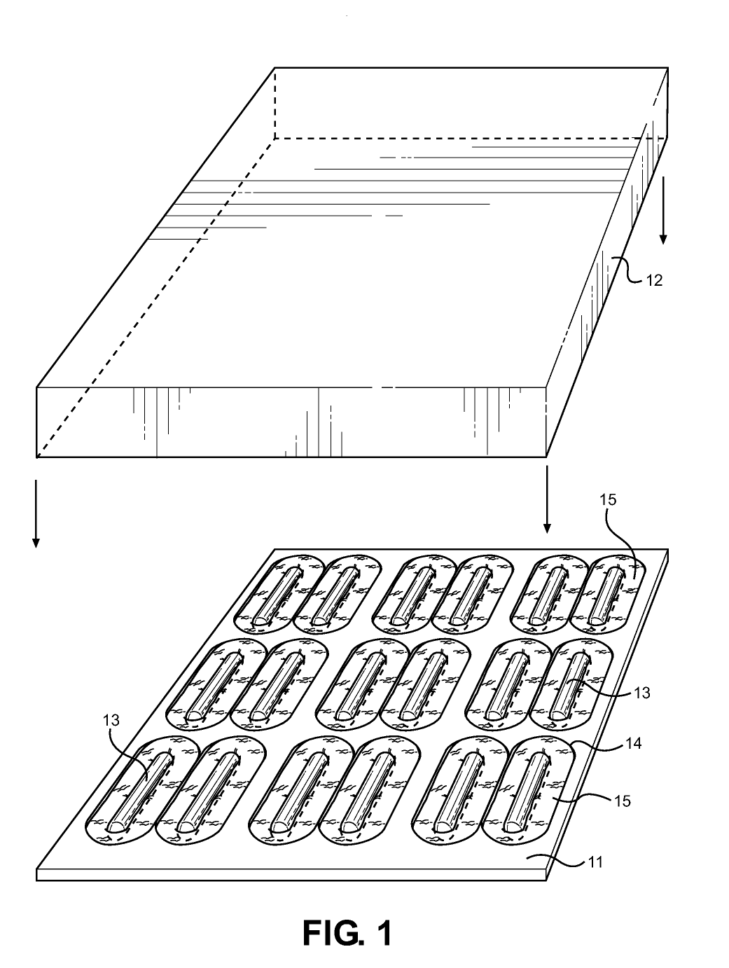

Referring now to FIG. 1, there is shown a sandwich bun-making mold according to the present invention. The device comprises a bread mold pan 11, a pan cover 12, and a plurality of inserts 13 of varying size. The bread mold pan 11 is preferably a rectangular baking pan. A plurality of bread mold recesses 14 is disposed across the surface of said bread mold pan 11. They may be positioned in rows and columns to maximize use of the pan surface area. These recesses 14 may be formed in the shape of a conjoined pair of bun halves (as shown in FIG. 1), or alternatively may be formed in the shape of individual bun halves. The recesses 14 are depressions in the bread pan 11 having arcuate walls that slope inward and meet along a smooth bottom portion. If the mold is formed in the shape of conjoined halves, then neighboring pairs of recesses 14 share a wall having a lesser height than that of the outside walls. The reduced height of the shared inner wall results in a thinner region of dough between two halves of the bun and allows the same to be folded over after baking into a unitary sandwich bun.

A plurality of baking inserts 13 is provided in a variety of sizes and shapes. A set may be provided for a user with different shapes and sizes to make full batches with differing inner recess qualities. A first set of inserts 13 may comprise cylindrical rods having varying length and diameter, along with rounded ends (as shown in FIG. 1). A second set of inserts may be formed in the shape of discs of varying height and diameter. Other shapes are contemplated, such as parallelepoids, tori, and other novelty shapes. An insert 13 is placed on top of yeast dough 15 and positioned within a mold recess 14 to create a hollow pocket of desired shape and size as the yeast dough rises and bakes. The placement and choice of insert 13 is dependent on user preferences. The inserts themselves may be constructed of metal, plastic, or any other heat-resistant, durable, oven-safe and optionally non-stick coated material

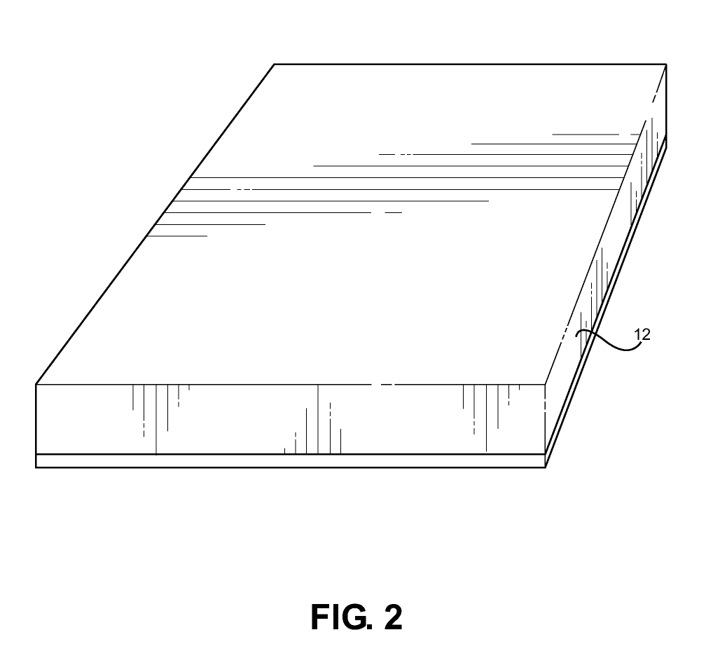

Referring now to FIG. 2, there is shown a perspective view of the present invention, wherein a sandwich bun mold device is shown with the pan cover 12 lowered. The pan cover 12 is geometrically shaped and in a preferred embodiment corresponds to the shape of the bread mold. The cover 12 fits over the top of the bread mold pan 11 such that inner surfaces of its walls abut against the sides of said pan 11 and provide a covering that allows stacking, provides coverage within the oven and may further facilitate the baking process. In an alternative embodiment the pan cover may be hingedly affixed along an edge of the pan and may be any shape that covers all bread recesses when the cover is lowered.

In a preferred embodiment, the bread mold pans 11 have mold recesses 14 formed in the shape of hot dog buns, wherein each half of a bun has an elongated, elliptical shape. In an alternative embodiment the recesses 14 may be larger ellipses for making submarine sandwich buns or hoagie rolls. In still another embodiment, the recesses 14 may be shaped like discs to create hamburger buns or sandwich rolls. The device may further be constructed of any type of baking pan material, such as metal, baking glass, or the like. The pan, as well as the insert, may comprise a non-stick coating to prevent dough from burning to the pan or clinging thereto after baking, which would make cleanup and the removal of baked buns more difficult.

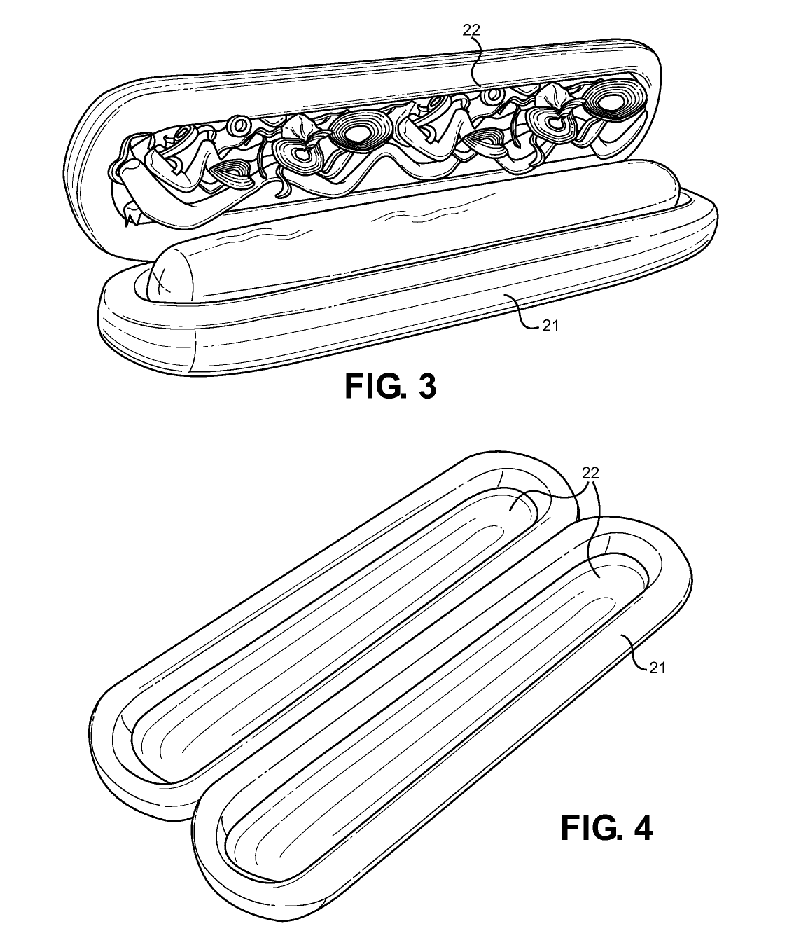

Regarding FIGS. 3 & 4 there is shown two perspective views of a hollow sandwich bun 21 produced via the present invention. The bun 21 shape shown is that of a hot dog bun, though other types of sandwich buns may be made using the present invention. Long, cylindrical recesses 22 are disposed along the interior surface of each bun half 21. Prior to consumption, a hot dog is placed within a recess on one bun half 21 (as shown in FIG. 3), and condiments are dispensed into the opposing bun half 21 recess 22. The bun halves 21 may then be folded together to bring the hot dog and condiments into contact. In use, the placement of the sandwich contents within recesses reduces spillage of either the hot dog or the associated condiments from the bun and onto a user or a ground surface. The two recesses 22 provide an effective structure for containing the sandwich contents during consumption.

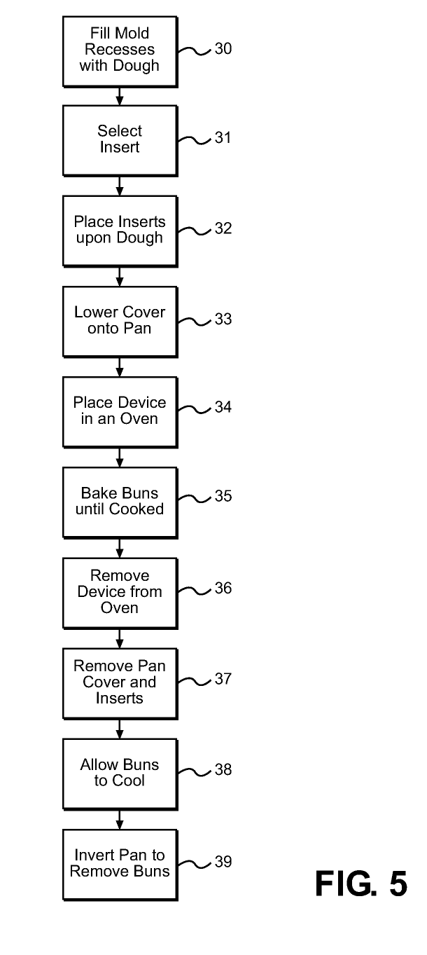

Referring now to FIG. 5, there is shown a visual depiction of the present method for creating a hollow sandwich bun. The bread mold recesses are first filled with yeast dough 30. The volume of dough placed in a mold recess may vary according to baking conditions and the size of the recesses provided on the pan. A user then selects the particular inserts to be used 31 according to a desired size and shape of the resulting hollow region within the finished bun product. Different sizes or shapes may be used during a single batch if desired. For instance, it may be desirable to have a larger insert to accommodate a large hot dog, while providing a smaller insert for an associated condiment bun half. The inserts are then placed on the surface of the yeast dough 32 and depressed slightly thereinto to settle the inserts into the dough and create the recesses. Inserts may be placed on different regions of corresponding bun halves or may be aligned symmetrically.

The pan cover is then placed over the bread mold pan 33 to prepare the assembly for baking. A user places the device in a preheated oven 34 and closes the same. The device should be baked until the dough rises and is fully cooked 35. It is permissible for the device to be temporarily removed from the oven so that a user may check the cooking progress of the dough. Once buns are cooked to a user's satisfaction, the device is removed from the oven 36 and the pan cover and baking inserts are removed from the device 37. The cooked buns should be allowed to cool within the bread mold pan 38 prior to a user inverting the tray for removal thereof. In this manner, a user may produce sandwich buns having varying shapes of hollow recesses within the buns to suit different situations, preferences and food products.

With respect to the above description then, it is to be realized that the optimum dimensional relationships for the parts and steps of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) A mold device for creating hollow sandwich buns, comprising:
a bread mold pan having a plurality of molded recesses disposed along its surface, wherein said recesses are adapted to receive and retain bread yeast dough;
a pan cover adapted to fit over and enclosure said pan surface;
a plurality of recess inserts, wherein said inserts are geometrically shaped objects placed on said bread yeast dough within said mold recesses prior to baking.

2) The device of claim 1, wherein said mold recesses are formed in the shape of conjoined bun halves.

3) The device of claim 2 wherein said bun recesses comprise two cylindrical bun-half recesses, each bun-half recess having arcuate walls connected at a smooth bottom surface, and said bun-half recesses sharing an interior wall having a height lesser than that of the outer walls, so that a finished bun product may be folded in half along an area formed by said inner wall during baking.

4) The device of claim 1, wherein said mold recesses are formed in the shape of a separate half of a sandwich bun.

5) The device of claim 1, wherein said mold recesses are formed in a shape suitable for hot dog buns.

6) The device of claim 1, wherein said mold recesses are formed in a shape suitable for hamburger buns.

7) The device of claim 1, wherein said mold recesses are formed in the shape of submarine sandwich rolls.

8) The device of claim 1, wherein said baking inserts comprises a plurality of cylindrical rods of different lengths and widths.

9) The device of claim 1, wherein said baking inserts comprise discs of varying diameter.

10) The device of claim 1, wherein said baking inserts comprise a plurality of geometric shapes.

11) The method of making sandwich buns having hollow regions of selectable size and shape, comprising the steps of:
placing bread yeast dough into a mold recess along a surface of a bread mold pan;
selecting a baking insert of desired size and shape desired for creating a hollow region within a sandwich bun;
placing said inserts on and depressing said inserts into, the surface of said bread dough within said mold recess;
lowering a pan cover over said bread mold pan;
placing said bread mold pan and pan cover into a preheated oven;
baking said bread mold pan and pan cover until said bread yeast dough is thoroughly cooked;
removing said bread mold pan and pain cover from said oven;
removing said pan cover and baking inserts from the bread mold pan;
allowing said bread mold pan to cool;
inverting said bread mold pan to remove cooked sandwich buns said pan.

12) The process of claim 11, wherein selecting said baking inserts further comprises selecting a single size and shape insert.

13) The process of claim 11, wherein placing said baking inserts further comprises placing said inserts in parallel alignment.
